(19) United States
(12) Patent Application Publication
(10) Pub. No.: US 2012/0103764 A1
(43) Pub. Date: May 3, 2012

(54) CONVEYOR BELT CONNECTOR

(75) Inventors: Richard T. Price, Lehi, UT (US); Byron Larson, South Jordan, UT (US)

(73) Assignee: Multi-Fill, Inc.

(21) Appl. No.: 12/916,316

(22) Filed: Oct. 29, 2010

(51) Int. Cl. B65G 15/30; B65B 35/24

(52) U.S. Cl. 198/844.2; 53/393

(57) ABSTRACT

A conveyor belt connector, adapted to connect first and second ends of an elongate flexible belt having a top and a bottom and operated substantially constantly under tension, includes a plurality of hooks, disposed at the first end of the belt, and a plurality of slots, disposed at the second end of the belt, configured to longitudinally pivotally attach to the plurality of hooks and connect the belt in a continuous loop.

### BACKGROUND

1. Field of the Invention

The present disclosure relates generally to conveyor belts. More particularly, the present disclosure relates to a conveyor belt connector that is simple to connect and disconnect, and is easy to keep clean.

2. Related Art

Conveyor belts are used in many industries to transport products. To create a continuous belt that can rotate around pulleys, drive wheels, etc., many conveyor belt systems have opposite ends of a flexible belt attached together with a hinge type connector. This arrangement can involve intermeshing hinge loop pieces on opposing ends of the belt, with a hinge pin extending through the loop pieces to connect the ends together. The hinge loop pieces can be stamped metal parts that are fastened to the ends of the belt. Alternatively, intermeshing hinge loop pieces can be wires that are stitched into the ends of the belt with a hinge pin therebetween, creating what is commonly called a stitched connection.

There are many industries, such as the food packaging industry, in which conveyor belts are removed and cleaned frequently. To facilitate removal, many conveyor belts are provided with a joint or connector that can be disconnected at will. Where these connectors have hinge pins, this requires removal and replacement of a very small pin on a frequent basis. This can be difficult and time-consuming, often requiring two workers to complete. Furthermore, hinge pins frequently become lost, further adding to the time, trouble and cost associated with the belt. Moreover, many conveyor belt connection devices provide numerous small crevices and locations for trapping debris. In the food packaging industry this is of particular concern because it makes the belts more difficult to clean completely, and provides more locations for entrapment of food particles, which can promote bacterial growth and other undesirable conditions.

### SUMMARY

It has been recognized that it would be advantageous to develop a conveyor belt connector that is simple to connect and disconnect, without parts that are prone to being lost.

It has also been recognized that it would be advantageous to have a conveyor belt connector that is easy to clean.

In accordance with one embodiment thereof, the present disclosure provides a conveyor belt connector, adapted to connect first and second ends of an elongate flexible belt having a top and a bottom and operated substantially constantly under tension. The conveyor belt connector includes a plurality of hooks, disposed at the first end of the belt, and a plurality of slots, disposed at the second end of the belt, configured to longitudinally pivotally attach to the plurality of hooks and connect the belt in a continuous loop.

In accordance with another aspect thereof, the disclosure provides a conveyor belt system. The system includes an elongate flexible belt of unitary construction, having first and second ends and a top and a bottom, and operable substantially constantly under tension. A plurality of hooks are attached to the first end of the belt, and a plurality of slots are attached to the second end of the belt. The slots are configured to longitudinally pivotally attach to the plurality of hooks and connect the belt in a continuous loop.

In accordance with yet another aspect thereof, the disclosure provides a food product packaging system. The system includes a conveyor, configured to transport a food product to a discharge location, and a food product packaging apparatus, positioned to receive the food product discharged from the conveyor, and to portion and dispense the food product into containers. The conveyor includes an elongate flexible belt with first and second ends and a top and a bottom, and operated substantially constantly under tension. A belt connector, including a plurality of hooks, is disposed at the first end of the belt, and a plurality of slots, are disposed at the second end of the belt, and configured to longitudinally pivotally attach to the plurality of hooks and connect the belt in a continuous loop.

### BRIEF DESCRIPTION OF THE DRAWINGS

Additional features and advantages of the disclosure will be apparent from the detailed description which follows, taken in conjunction with the accompanying drawings, which together illustrate, by way of example, features of the disclosure, and wherein:

FIG. 1 is a side view of a food product transport device positioned adjacent to a food product packaging machine;

FIG. 2 is a perspective view of a bulk food transport device with a conveyor belt having one embodiment of a conveyor belt connector in accordance with the present disclosure;

FIG. 3 is a close-up perspective view of a portion of a conveyor belt having an embodiment of a conveyor belt connector in accordance with the present disclosure;

FIG. 4 is a perspective view of the conveyor belt connector of FIG. 3 in a disconnected configuration;

FIGS. 5A and 5B are side edge views of the conveyor belt connector embodiment of FIG. 4, showing the connector in connected and disconnected configurations, respectively;

FIG. 6 is an exploded view of the hook portion of the conveyor belt connector of FIG. 4; and

FIG. 7 is an exploded view of the slot portion of the conveyor belt connector of FIG. 4;

FIG. 8 is a side edge view of an alternative embodiment of a conveyor belt connector in accordance with the present disclosure, in which the hooks and slots of the connector are substantially in line with the bottom of the belt;

FIG. 9 is a side edge view of an alternative embodiment of a conveyor belt connector in accordance with the present disclosure, in which the hooks and slots of the connector are substantially in line with neither the top nor bottom of the belt;

FIGS. 10A-B are top views of another embodiment of a conveyor belt connector in accordance with the present disclosure;

FIGS. 11A and 11B are side edge views of the conveyor belt connector embodiment of FIG. 10, showing the connector in connected and disconnected configurations, respectively;

FIGS. 12A-B are top views of another embodiment of a conveyor belt connector in accordance with the present disclosure; and

FIGS. 13A and 13B are side edge views of the conveyor belt connector embodiment of FIG. 12, showing the connector in connected and disconnected configurations, respectively.

### DETAILED DESCRIPTION

Reference will now be made to exemplary embodiments illustrated in the drawings, and specific language will be used herein to describe the same. It will nevertheless be understood that no limitation of the scope of the disclosure is thereby intended. Alterations and further modifications of the inventive features illustrated herein, and additional applications of the principles illustrated herein, which would occur to one skilled in the relevant art and having possession of this disclosure, are to be considered within the scope of the disclosure.

As noted above, there are a variety of connection devices for conveyor belts. Many of these include intermeshing hinge loops with a pin that extends through them, creating a pivoting connector. Unfortunately, with conveyor belts that are removed frequently for cleaning, this configuration can be difficult and time-consuming to maintain. Removal and replacement of a belt can require multiple workers; cleaning the connector region of the belt can be more difficult; and hinge pins frequently become lost, further adding to the time, trouble and cost associated with the belt.

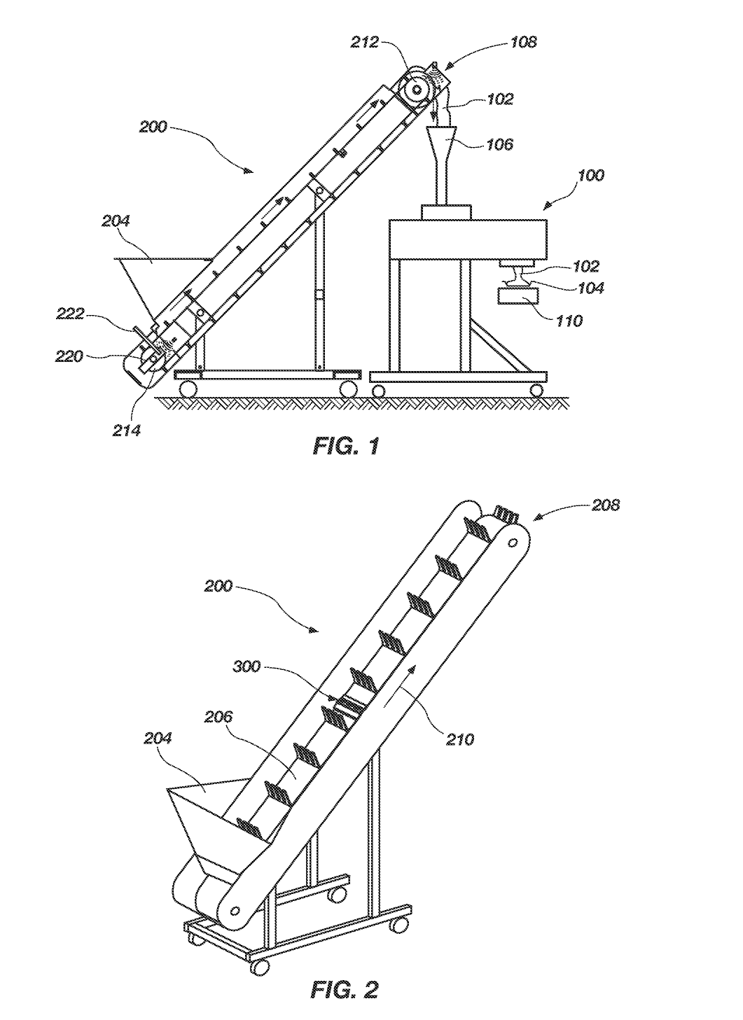

These issues are of particular concern in the food product packaging industry, where food products are transported by conveyors to packaging and other machines, since these conveyors are removed and cleaned usually multiple times per day. Provided in FIG. 1 is a side view of a food product transport device 200 (i.e. a conveyor) positioned adjacent to a food product packaging machine 100 that is positioned to receive food product 102 discharged from the conveyor 200, and to portion and dispense the food product into containers 104. While the conveyor 200 and food product packaging machine 100 are depicted as separate devices in FIG. 1, it is to be understood that the two devices could also be connected together as a single apparatus for conveying and portioning product into containers. It will be apparent that conveyors, such as food product conveyors, can be used in a variety of orientations, depending on the application and surrounding conditions. For example, a conveyor can be positioned to move product in a generally horizontal direction, or it can be oriented to move product from a lower position to a higher position, or from a higher position to a lower position. In FIG. 1, the product conveyor 200 is upwardly oriented to transport the food product 102 from a hopper 204 at a first lower position, to an elevated discharge position 108 adjacent to an inlet 106 of the food product packaging machine 100. This packaging machine is located adjacent to a container conveyor 110, and is positioned to receive the food product discharged from the conveyor 200, and to portion and dispense the food product into containers 104. The container conveyor 110 moves the product containers 104 past the product packaging machine 100, which dispenses measured quantities of food product 102 into each container as it passes by on the container conveyor. A volumetric pocket filling machine that can be used in this way is commercially available from Multi-Fill, Inc. of West Jordan, Utah.

It is to be understood that the food product packaging machine 100 shown in FIG. 1 is only one example of a machine that can be used with a product conveyor 200 as described herein. A conveyor system like that disclosed herein can be used with a wide variety of product packaging apparatus in addition to that shown herein, and moreover can be used with a wide variety of other types of machines and products, in addition to food product packaging machines.

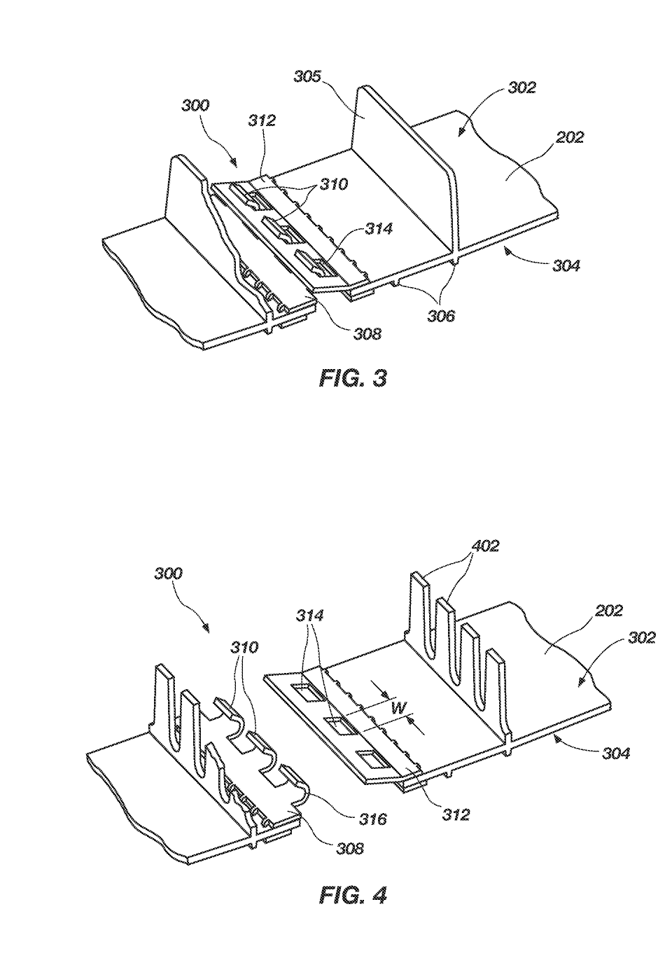

Shown in FIG. 2 is a side view of an embodiment of a bulk food transport device 200 with a conveyor belt 202. The bulk food transport device includes a hopper 204 positioned at a first end 206 of the conveyor, and has an unenclosed discharge location 208 at the opposite end. Motion of the conveyor belt in the direction of arrow 210 transports food product from the hopper 204 to the discharge location 208. The conveyor belt is a continuous belt that extends between a drive pulley 212 and an idler pulley 214. The drive pulley is attached to an electric motor, which provides power to drive the belt. The drive pulley 212 can include teeth (not shown) that intermesh with drive cleats extending from the bottom of the belt, to help provide more positive driving force to the belt. The drive cleats are shown in more detail in FIGS. 3 and 4, for example.

The transport device also includes a belt tensioning mechanism 220, which includes a belt tensioning lever 222 interconnected to a cam mechanism or the like (not shown) for adjusting the lateral position of one of the conveyor belt pulleys to allow adjustment of tension on the belt. When a user moves the belt tensioning lever 222 in one direction, the associated pulley is drawn away from the other pulley, thus applying tension to the belt. The tensioning mechanism 220 is configured to be locked in the tension position during operation of the conveyor device. When the tensioning lever 222 is moved in the opposite direction, the position of the associated pulley moves toward the other pulley, thus releasing tension on the belt. In this condition, the belt can be disconnected at its connector location, and removed from the conveyor device for cleaning, maintenance, etc.

Advantageously, a conveyor belt connector 300 has been developed that can be used with the conveyor belt 202, which does not require a hinge pin, and makes the belt relatively easy to remove, clean, and replace. Provided in FIG. 3 is a close-up perspective view of a portion of a conveyor belt 202 having an embodiment of a conveyor belt connector 300 in accordance with the present disclosure. FIG. 4 provides a perspective view of the same connector in a disconnected configuration.

The conveyor belt 202 is an elongate flexible belt, having a top 302 and a bottom 304. The belt can be of unitary construction (i.e. of a single piece from one end to the other), and made of a variety of materials. Polymer materials such as polypropylene and nitrile rubber are considered suitable for this type of belt, though other materials can also be used, depending on the application. The belt can be of one material, or it can be a composite of several different types of materials. For example, a vulcanized belt having multiple layers including woven fabrics and polymer layers can be used. The belt can also include a variety of features, such as upright paddles 305, shown in FIG. 3, or upstanding fingers 402, shown in FIG. 4, extending from the top of the belt for assisting movement of product thereupon. The belt can also include features extending downwardly from the bottom of the belt, such as drive cleats 306 discussed above, and shown in FIGS. 3 and 4, and subsequent figures.

The belt connector 300 generally comprises a hook assembly 308 having a plurality of hooks 310, which is attached at one end of the belt 202, and a slot assembly 312 that is attached to the other end of the belt, and includes a corresponding number of slots 314. The slots 314 are configured to longitudinally pivotally attach to the plurality of hooks 310, to connect the belt 202 in a continuous loop. Each hook 310 has a curved apex 316, allowing each connection with a corresponding slot 314 to pivot about an axis parallel to the width of the belt, similar to hinged belts, thereby allowing the belt connector easily to pass over pulleys, guide wheels and such. In this way the hooks longitudinally pivotally attach to the plurality of slots and connect the belt in a continuous loop. The size and number of hooks 310 can vary, as can the size and number of slots 314. This belt connector can provide adequate attachment of opposing ends of belts that are configured to be operated substantially constantly under tension, without additional structure and complexity.

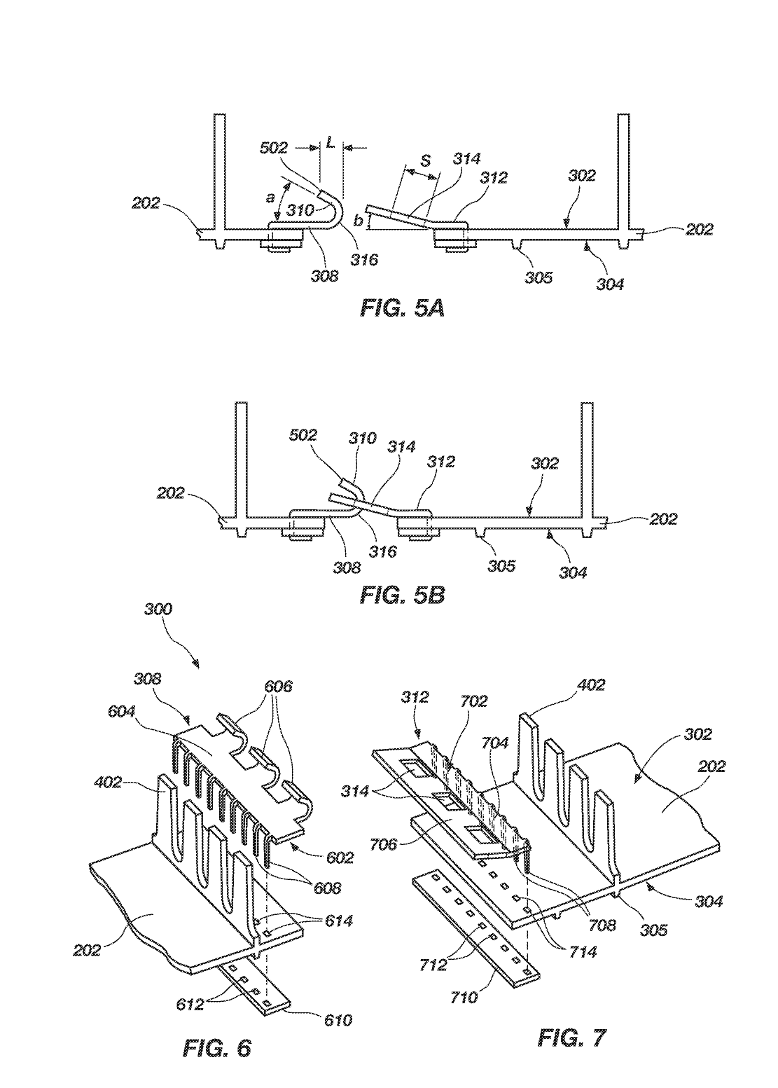

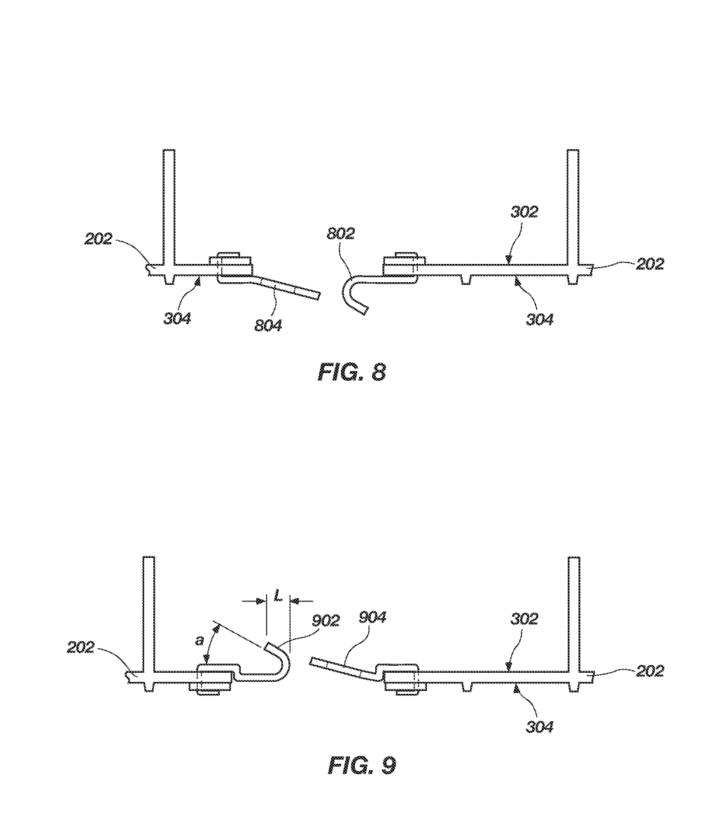

Provided in FIGS. 5A-B are side edge views of an embodiment of the hook portion and slot portion of the conveyor belt connector of FIG. 4. In the embodiment of FIG. 5, the free ends 502 of the hooks 310 are oriented upward, toward the top 302 of the belt 202. However, the hooks can be oriented the other way, with the free ends 502 of the hooks pointing toward the bottom 304 of the belt, as shown in FIG. 8. The shape and configuration of the hooks and slots can vary. In the embodiment of FIGS. 5A-B, the hooks 310 are angled with respect to the belt 202 at an angle a of about 30°. The angle of the hooks can vary. For example, in the embodiment of FIG. 9, the hooks have an angle of about 20°. Angles of from 15° to 30° have been used, but it is believed that other angles can also be suitable. A wider angle makes connecting and disconnecting the belt easier, while a smaller angle can increase the security of the connection.

The configuration of the free end 502 of the hooks can also vary. For example, the length L of the hooks can vary, as well as the angle of the hook opening and the radius of the apex 316 of the hooks. In the embodiment of FIGS. 5A-B, the hooks have a free end 502 with a length L of about 0.19″, an opening angle of 20°, and a hook apex radius of about 0.1″. In the embodiment of FIG. 9, on the other hand, the hooks have a free end with a length L of 0.30″, an opening angle a of 30, and a hook radius of about 0.12″. Hook configurations with dimensions between or outside of these values can also be used. For example, it is believed that the dimension L can vary from 0.19″ to 1.5″. It is believed that a suitable hook radius can be in the range of 0.06″ to 0.25″. In general, the dimensions of the hooks should be proportional to the size and thickness of the belt and the loads that are expected to be imposed thereon.

The configuration of the slots 314 can also vary. Referring to FIG. 5A, Like the hooks 310, the slots can be attached to the belt with an angle b that bears away from the belt. Angles b of from 0° to 45° have been used, though it is believed that other angles can also be used. It will be apparent that the width w of the slots (shown in FIG. 4) will be some amount greater than the width of the corresponding hook, to allow entrance of the hook. If the slot is too small, it will be difficult to insert the hook. However, if the slot is too wide, there can be excessive play in the belt connection. Likewise, larger slots can tend to allow material to drop through the belt since the hooks will not completely fill the slots. In one embodiment the slots are 9% wider than the corresponding hook. It is believed that a slot width that is about 2% to 20% greater than the hook width can work for most belts.

The length s of the slots, measured along the long axis of the belt, can also vary, and is primarily dependent upon the thickness of the material of the connector (e.g. metal plate, etc.) and the geometry of the hook. For example, the slot length can depend upon the length of the free end and the opening angle of the hooks. A longer slot will accommodate a hook with a longer free end and/or smaller opening angle and thicker hook material. On the other hand, a hook with a shorter free end and/or wider opening angle can fit into a shorter slot. In general, it is believed that slots having a length of from 0.06″ to 1″ can be used with metal belt connectors fabricated from 0.04″ stainless steel plate and having geometry and dimensions like those outlined above with respect to FIGS. 5A-B. It will also be appreciated that longer slots can make attaching the connector easier, whereas shorter slots can make it more difficult to insert the hooks into the slots, in which case connecting may involve flexing the belt, etc., depending on the tension on the belt and how much play is available.

The position of the hook and slot fittings with respect to the ends of the belt can vary. However, it is considered generally desirable to place the fittings such that, when connected, the ends of the belt are brought as close together as possible without interfering with attachment of the belt. Having the ends of the belt closer together allows the belt to be more flexible around pulleys.

In the embodiment of FIGS. 5A-B, the hooks and slots are substantially in line with the top of the belt. That is, the slot assembly extends from the top 302 of one end of the belt 202, and the hook assembly extends from the top 302 of the other end of the belt 202. However, other configurations can be used. For example, as shown in FIG. 8, the hooks 802 and slots 804 can be substantially aligned with the bottom 304 of the belt 202. As another alternative, the hooks 902 and slots 904 can be aligned with neither the top 302 nor bottom 304 of the belt, as shown in FIG. 9, but instead positioned between the top and bottom surfaces.

The belt connector embodiments shown herein involve metal belt connector fittings, having either hooks or slots, attached to opposing ends of the belt. The metal fittings can be of stainless steel, or other suitable metal. Other materials, such as polymers, molded plastic, etc., can also be used so long as the connector fittings have adequate mechanical strength. These connector fittings can be mechanically attached to the belt in a variety of ways. As shown in the exploded view of FIGS. 6 & 7, the conveyor belt connector can comprise a hook assembly 308 including a hook plate 602, having a substantially flat portion 604 substantially as wide as the belt 202, and a hook group 606 extending from a first edge of the plate and a plurality of pins 608 extending substantially perpendicularly from a second edge of the plate. The hook assembly 308 also includes a backer plate 610, having a length comparable to the width of the belt, with a plurality of apertures 612 extending through it, the number and spacing of apertures 612 in the backer plate corresponding to the number of and spacing of the pins 608 of the flat portion 604 of the hook plate 602. The belt 202 can also include corresponding apertures 614 for the pins.

To attach the hook fitting 600 to the belt, the backer plate 610 is placed against one side of the belt 202, and the pins 608 of the hook plate 602 are pressed through the belt 202 and into the apertures 612 in the backer plate 610. Then the pins 608 are permanently mechanically bent or crimped against the backer plate 610, such as using a press or similar device, to mechanically affix the hook fitting to the belt.

The slot fitting can be attached in a similar manner. As shown in FIG. 7 the slot fitting, indicated generally at 312, includes a slot plate 702, comprising a substantially flat plate 704 having a width comparable to the width of the belt 202, with a slot flange 706 extending from a first edge of the plate, and a plurality of pins 708 extending substantially perpendicularly from a second edge of the plate. The slot fitting 700 also includes a backer plate 710, having a length comparable to the width of the belt, with a plurality of apertures 712 extending through it, the number and spacing of apertures in the backer plate corresponding to the number of and spacing of the pins 710 of the slot plate. The belt can also include corresponding apertures 714 for these pins. Like the hook fitting 600, to attach the slot fitting 700 the backer plate 710 is placed against one side of the belt, and the pins 708 of the slot plate are pressed through the belt and into the apertures 712 in the backer plate 710. The pins are then bent or crimped against the backer plate, to mechanically affix the slot fitting to the belt.

It is to be appreciated that the method of attachment of the fittings to the end of the belt depicted herein is only one of many possible methods for mechanically attaching the hook and slot fittings. Many other methods of mechanical attachment can also be used, such as screws, bolts, rivets, wire staples or stitching, chemical adhesive, etc., and these various methods can be used with both metal and polymer fittings. For example, the type of connection method shown and described with respect to FIGS. 6 and 7 can also be used with plastic connector components. In such a case, for example, the pins that extend from the hook and slot fittings can be thermally welded to a backer plate. It is also to be appreciated that the use of fittings attached to the belt is also only one of a variety of methods for providing the hooks and/or slots. For example, depending on the material of the belt, slots can be created directly in the belt material near an end thereof, and the opposite end of the belt can have hooks that fit into the slots in the belt material.

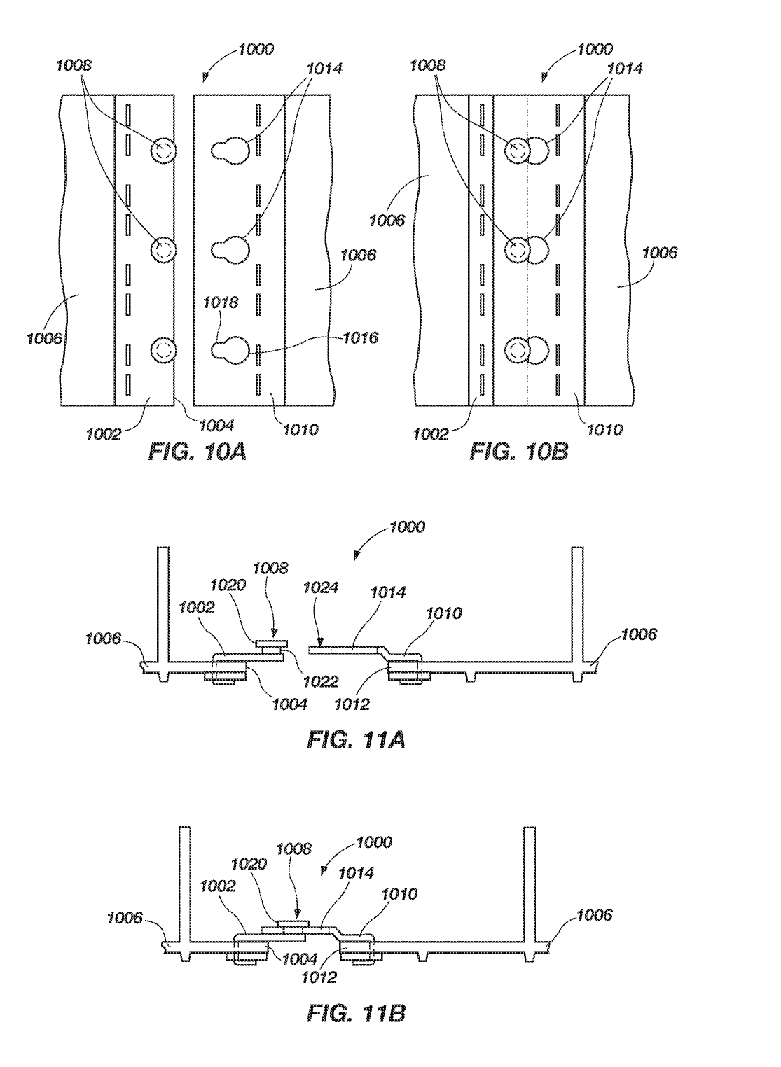

Conveyor belt connectors in accordance with the present disclosure can be configured in other ways, as well. Shown in FIGS. 10A-B and 11A-B are top and side edge views of another embodiment of a conveyor belt connector, indicated generally at 1000, which includes a hook end 1002 attached to a first end 1004 of an elongate belt 1006, with a plurality of upstanding buttons 1008. The slot end 1010 of the connector 1000 is attached to the opposite end 1012 of the belt 1006, and includes a plurality of key slots 1014, having sizes and positions that correspond to those of the buttons 1008, and into which the upstanding buttons insert. As shown FIG. 10A, each key slot 1014 includes a larger diameter first end 1016, and a smaller diameter second end 1018. Each button 1008 includes a larger diameter top 1020, with a smaller diameter post 1022.

To attach the hook end 1002 to the slot end 1010 of the connector 1000, a user slides the top 1020 of each button 1008 into the large first end 1016 of the corresponding slot 1014 until the top 1020 of the buttons 1008 protrude above the top surface 1024 of the slot end 1010 of the connector. The user then slides the buttons 1008 toward the second end 1018 of the slots 1014 by pulling the respective ends of the belt 1006 away from each other, until the posts 1022 of the buttons 1008 fit into the smaller ends 1018 of the slots. With tension applied to the belt, the buttons 1008 will remain locked into the corresponding slots 1014, providing a secure belt connection. It is to be understood that the size, shape, number, and placement of the buttons (or comparable structure) and slots (or comparable structure) can vary from that shown in the figures. Interlocking posts and slots can be configured in a variety of ways to connect belts together in the manner disclosed herein. Materials of construction of the conveyor belt connector can also vary.

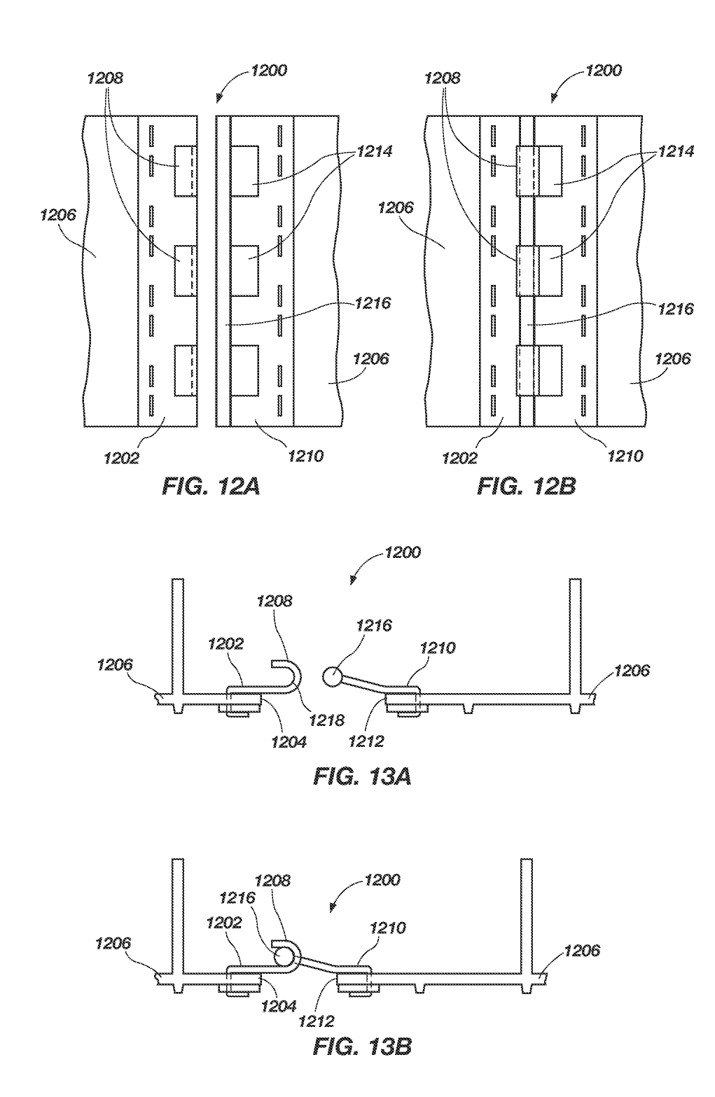

Another embodiment of a belt connector in accordance with the present disclosure is shown in FIGS. 12A-B and 13A-B. This embodiment of a connector, indicated generally at 1200, includes a hook end 1202 attached to a first end 1204 of an elongate belt 1206, with a plurality of curved hooks 1208 similar to the hooks in the embodiment of FIG. 3. The slot end 1210 of the connector 1200 is attached to the opposite end 1212 of the belt 1206, and includes a plurality of open slots 1214, with a transverse bar 1216 that extends across and closes each slot. The transverse bar can be attached to the slot end 1210 of the connector via welding or the like. In the embodiment shown in FIGS. 12A-B and 13A-B the transverse bar 1216 is substantially circular in cross section, and allows the hooks 1208 to freely pivot, while also providing a secure attachment.

To attach the hook end 1202 to the slot end 1210 of the connector 1200, a user slides the transverse bar 1216 over the top of each hook 1208, then pulls the slot end 1210 of the belt away from the opposing end 1204, so that the transverse bar 1216 fits into the curved apex 1218 of each hook 1208. With tension applied to the belt 1206, the hooks will remain interlocked with the transverse bar 1216, providing a secure belt connection that can easily pivot around pulleys, etc. It is to be understood that the size, shape, number, and placement of the hooks, slots and the transverse bar can vary from that shown in the figures. Materials of construction of the conveyor belt connector can also vary.

The present disclosure thus provides a pivoting conveyor belt connector that does not require hinge pins, and can be connected or disconnected without the need for tools. The connector includes hooks at one end of a belt and corresponding slots at the other end of the belt. With this connector, a single worker can connect or disconnect the belt quickly and easily, and there are no small parts to be lost. The connector functions well for any belt that is held in tension, which covers a wide range of conveyor belt applications. In actual practice, a single belt will presumably have only one connector, though a belt can be comprised of multiple segments attached by multiple belt connectors. For example, if a belt becomes torn or broken, it can be repaired by using two connectors to insert a new belt segment, rather than replacing the entire belt.

It is to be understood that the above-referenced arrangements are illustrative of the application of the principles of the present disclosure. It will be apparent to those of ordinary skill in the art that numerous modifications can be made without departing from the principles and concepts set forth in the claims.

What is claimed is:

1. A conveyor belt connector, comprising:
an elongate flexible conveyor belt having first and second ends and a top and a bottom, and operated substantially constantly under tension;
a plurality of hooks, disposed at the first end of the belt; and
a plurality of slots, disposed at the second end of the belt, configured to longitudinally pivotally attach to the plurality of hooks and connect the belt in a continuous loop.

2. A conveyor belt connector in accordance with claim 1, wherein the hooks have a free end oriented toward one of the top of the belt and the bottom of the belt.

3. A conveyor belt connector in accordance with claim 1, wherein the hooks and slots are substantially in line with the top of the belt.

4. A conveyor belt connector in accordance with claim 1, wherein the hooks and the slots each comprise a metal fitting mechanically attached to the first and second ends of the belt, respectively.

5. A conveyor belt connector in accordance with claim 4, wherein the metal fittings are of stainless steel, and the belt is of polypropylene.

6. A conveyor belt connector in accordance with claim 1, wherein the hooks comprise upstanding buttons, and the slots comprise key slots, into which the buttons mechanically lock.

7. A conveyor belt connector in accordance with claim 1, wherein the slots comprise open slots with a transverse bar disposed at an open end thereof, the hooks being configured to hook upon the transverse bar.

8. A conveyor belt connector in accordance with claim 1, further comprising at least one of upwardly oriented fingers extending from the top of the belt, upwardly oriented paddles extending from the top of the belt, and downwardly oriented drive cleats extending from the bottom of the belt.

9. A conveyor belt system, comprising:
an elongate flexible belt, having first and second ends and a top and a bottom, and operable substantially constantly under tension;
a plurality of hooks, attached to the first end of the belt; and
a plurality of slots, attached to the second end of the belt, configured to longitudinally pivotally attach to the plurality of hooks and connect the belt in a continuous loop.

10. A conveyor belt system in accordance with claim 9, wherein the hooks have a free end oriented toward one of the top of the belt and the bottom of the belt.

11. A conveyor belt system in accordance with claim 9, wherein the belt is of a polymer material, and the hooks and the slots each comprise a stainless steel fitting mechanically attached to the first and second ends of the belt, respectively.

12. A conveyor belt system in accordance with claim 9, wherein the hooks comprise upstanding buttons, and the slots comprise key slots, into which the buttons mechanically lock.

13. A conveyor belt system in accordance with claim 9, wherein the slots comprise open slots with a transverse bar disposed at an open end thereof, the hooks being configured to hook upon the transverse bar.

14. A conveyor belt system in accordance with claim 9, wherein the hooks and slots are substantially in line with one of the top of the belt, the bottom of the belt, and neither the top nor bottom of the belt.

15. A conveyor belt system in accordance with claim 9, further comprising at least one of upwardly oriented fingers extending from the top of the belt, upwardly oriented paddles extending from the top of the belt, and downwardly oriented drive cleats extending from the bottom of the belt.

16. A product packaging system, comprising:
a conveyor, configured to transport a product to a discharge location, having
an elongate flexible belt with first and second ends and a top and a bottom, and operated substantially constantly under tension; and
a belt connector, including a plurality of hooks, attached to the first end of the belt and a plurality of slots, attached to the second end of the belt, configured to longitudinally pivotally attach to the plurality of hooks and connect the belt in a continuous loop.

17. A product packaging system in accordance with claim 16, further comprising a product packaging apparatus, positioned to receive the product discharged from the conveyor, and to portion and dispense the product into containers.

18. A product packaging system in accordance with claim 16, wherein the hooks comprise upstanding buttons, and the slots comprise key slots, into which the buttons mechanically lock.

19. A product packaging system in accordance with claim 16, wherein the hooks have a free end oriented toward one of the top of the belt and the bottom of the belt.

20. A product packaging system in accordance with claim 16, wherein the slots comprise open slots with a transverse bar disposed at an open end thereof, the hooks being configured to hook upon the transverse bar.
